(19) United States
(12) Patent Application Publication
(10) Pub. No.: US 2018/0209936 A1
(43) Pub. Date: Jul. 26, 2018

(54) ELECTROCHEMICAL MEASUREMENT DEVICE AND ELECTROCHEMICAL MEASUREMENT SYSTEM

(71) Applicant: Panasonic Intellectual Property Management Co., Ltd., Osaka (JP)

(72) Inventors: HIROSHI USHIO, Osaka (JP); MASAHIRO YASUMI, Osaka (JP)

(21) Appl. No.: 15/746,010

(22) PCT Filed: Oct. 19, 2016
(86) PCT No.: PCT/JP2016/004619

§ 371 Date: Jan. 19, 2018

(30) Foreign Application Priority Data
Oct. 22, 2015 (JP) 2015-207703

(51) Int. Cl. G01N 27/49

(52) U.S. Cl. CPC G01N 27/49

(57) ABSTRACT

An electrochemical measurement device is configured to measure an activity of a biological sample with a measuring liquid having conductivity. The device includes a plate having first and second wells provided therein, a measuring electrode disposed inside the first well, and a first placement portion provided configured to have the biological sample placed thereon. The first and second wells are provided in an upper surface at positions different from each other. The plate includes a wall separating a bottom surface of the first well from a bottom surface of the second well. The measuring electrode is provided on the bottom surface of the first well around the first placement portion. The second well is configured to have a counter electrode disposed therein. The first and second wells are configured to contain the measuring liquid therein. A portion of the measuring liquid contained in the first well is electrically connected to a portion of the measuring liquid contained in the second well. This electrochemical measurement device can perform electrochemical measurement in plural wells in a short time.

### TECHNICAL FIELD

The present disclosure relates to an electrochemical measurement device and an electrochemical measurement system for performing electrochemical measurement of a biological sample, such as a cell.

### BACKGROUND ART

As a method for examining the activity state of a biological sample such as a fertilized ovum, a respiratory activity measurement method using electrochemical measurement is known.

For example, a respiratory activity measuring apparatus for measuring the respiratory activity of an embryo includes a chip for respiration measurement and an analysis unit. The chip for respiration measurement includes a substrate in which an electrode is disposed, a plurality of wells for introducing an embryo, and a micro passage. One embryo is introduced into each of the wells. A counter electrode and a reference electrode are interposed inside the well into which the embryo is introduced. In electrochemical measurement, a measurement potential is applied to a working electrode, the counter electrode, and the reference electrode of the chip for respiration measurement. The analysis unit calculates the amount of oxygen consumed by the embryo from current values measured before and after the introduction of the embryo in a state in which the potential is applied to the chip for respiration measurement. The respiratory activity measuring apparatus determines the respiratory activity and activity state of the embryo from the calculated amount of oxygen consumed by the embryo.

PTL 1 discloses a respiratory activity measuring apparatus similar to the above-mentioned respiratory activity measuring apparatus.

### CITATION LIST

### Patent Literature

PTL 1: Japanese Patent Laid-Open Publication No. 2010-121948

### SUMMARY

An electrochemical measurement device is configured to measure an activity of a biological sample with a measuring liquid having conductivity. The device includes a plate having first and second wells provided therein, a measuring electrode disposed inside the first well, and a first placement portion provided configured to have the biological sample placed thereon. The first and second wells are provided in an upper surface at positions different from each other. The plate includes a wall separating a bottom surface of the first well from a bottom surface of the second well. The measuring electrode is provided on the bottom surface of the first well around the first placement portion. The second well is configured to have a counter electrode disposed therein. The first and second wells are configured to contain the measuring liquid therein. A portion of the measuring liquid contained in the first well is electrically connected to a portion of the measuring liquid contained in the second well.

This electrochemical measurement device can perform electrochemical measurement in plural wells in a short time.

### BRIEF DESCRIPTION OF DRAWINGS

FIG. 1 is a perspective view of an electrochemical measurement device according to an exemplary embodiment.

FIG. 2 is a top view of the electrochemical measurement device according to the embodiment.

FIG. 3 is a cross-sectional view of the electrochemical measurement device along line III-III shown in FIG. 2.

FIG. 4 is a cross-sectional view of the electrochemical measurement device along line IV-IV shown in FIG. 2.

FIG. 5 is an enlarged cross-sectional view of the electrochemical measurement device illustrated in FIG. 4.

FIG. 6 is a top view of wells of the electrochemical measurement device according to the embodiment.

FIG. 7 is a schematic diagram of an electrochemical measurement system according to the embodiment.

FIG. 8 is a top view of another electrochemical measurement device according to the embodiment.

FIG. 9 is a top view of still another electrochemical measurement device according to the embodiment.

FIG. 10 is a perspective view of a further electrochemical measurement device according to the embodiment.

FIG. 11 is a top view of a further electrochemical measurement device according to the embodiment.

FIG. 12 is a top view of a further electrochemical measurement device according to the embodiment.

FIG. 13 is an enlarged cross-sectional view of a further electrochemical measurement device according to the embodiment.

FIG. 14 is a cross-sectional view of a further electrochemical measurement device according to the embodiment.

FIG. 15 is a cross-sectional view of a further electrochemical measurement device according to the embodiment.

### DETAIL DESCRIPTION OF EXEMPLARY EMBODIMENT

Hereinafter, an electrochemical measurement device and an electrochemical measurement system according to embodiments of the present disclosure will be described in detail with reference to the drawings. It should be noted that each of the embodiments described below represents a specific preferred example of the present disclosure. Therefore, numerical values, shapes, materials, constituents, and the arrangement and connection of the constituents, each being mentioned in the following embodiments, are merely exemplary, and are not intended to limit the scope of the present disclosure. Thus, among the constituents in the following embodiments, constituents not recited in any one of the independent claims which indicate the broadest concepts of the present disclosure are described as arbitrary constituents.

The drawings are schematic diagrams, and are not necessarily strictly made. In the drawings, constituents having substantially the same configuration are assigned the same reference signs, and duplicate descriptions of the constituents are omitted or simplified.

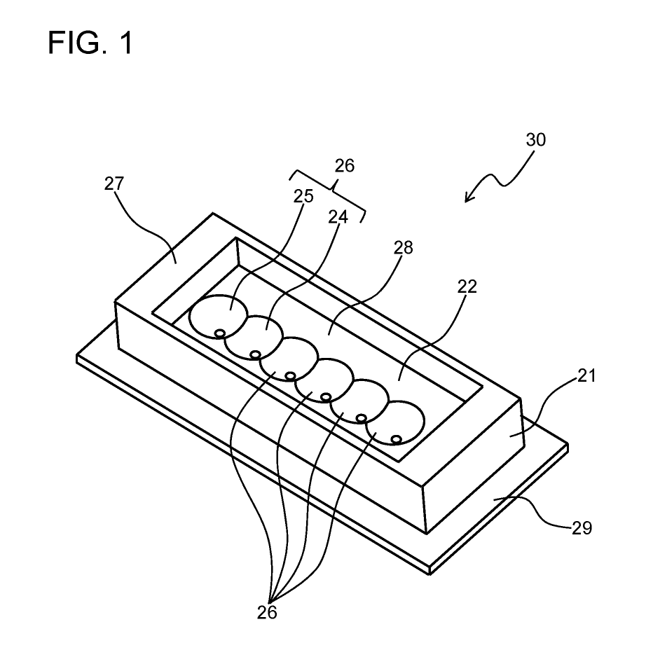

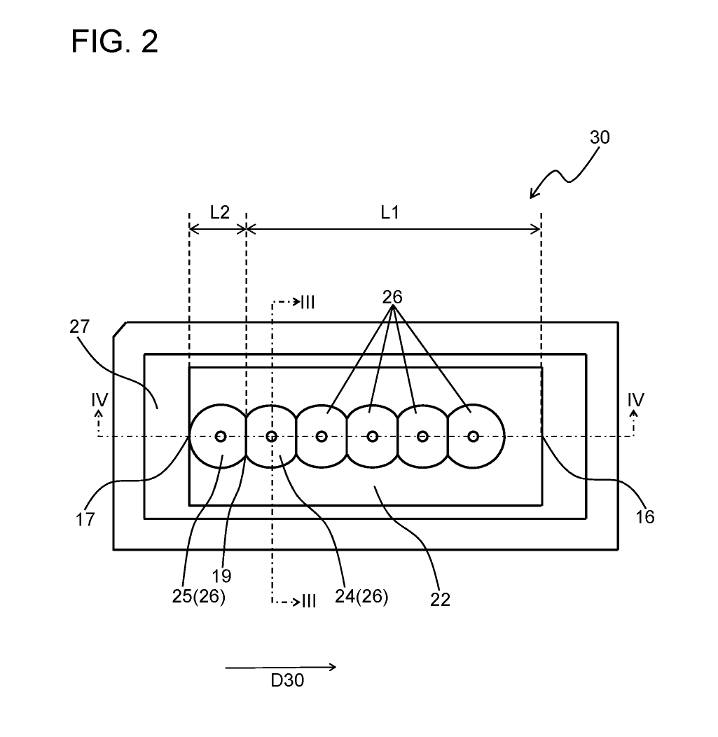

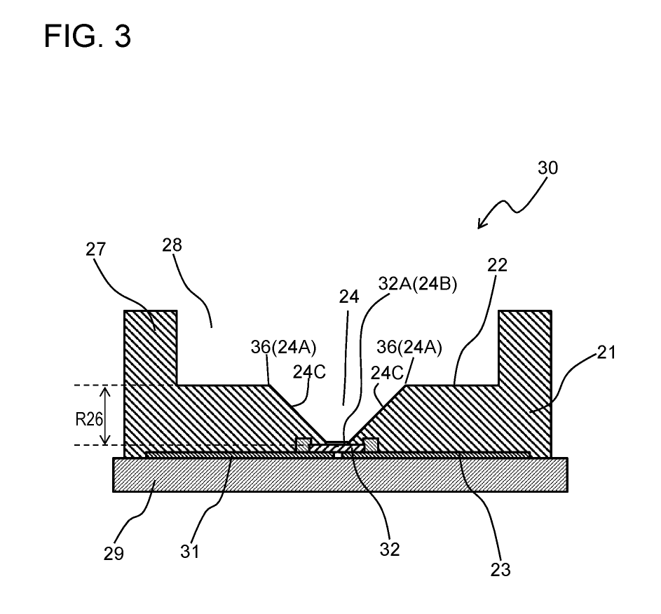

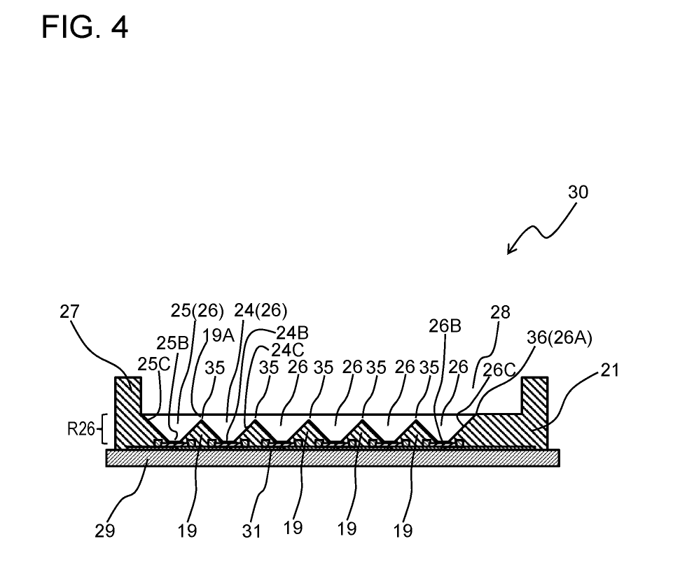

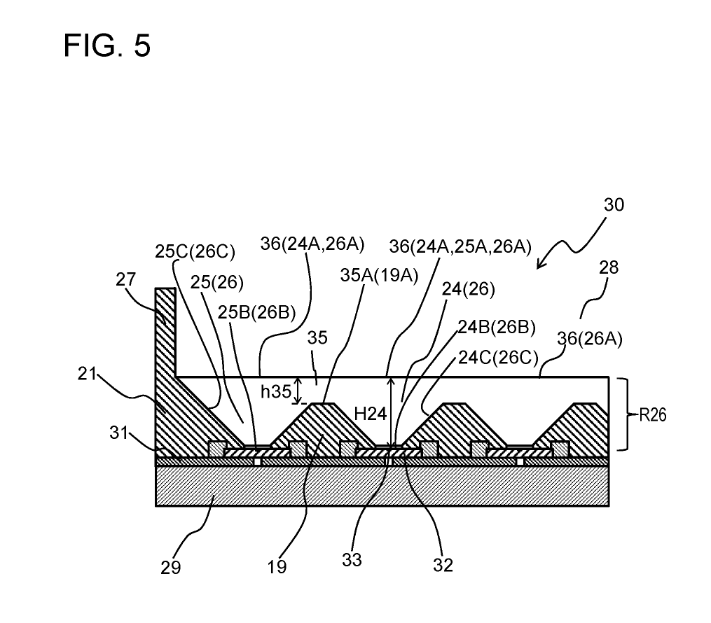

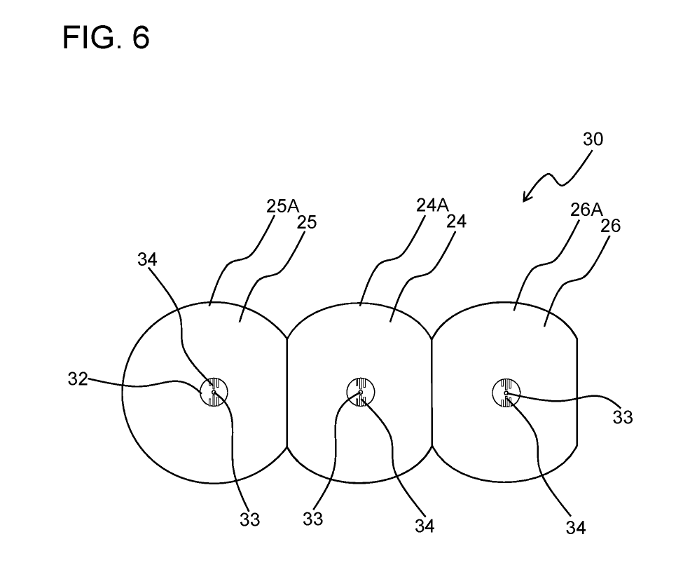

FIG. 1 and FIG. 2 are a perspective view and a top view of electrochemical measurement device 30 according to an embodiment, respectively. FIG. 3 is a cross-sectional view of electrochemical measurement device 30 along line III-III shown in FIG. 2. FIG. 4 is a cross-sectional view of electrochemical measurement device 30 along line IV-IV shown in FIG. 2. FIG. 5 is an enlarged cross-sectional view of electrochemical measurement device 30 illustrated in FIG. 4. FIG. 6 is an enlarged top view of electrochemical measurement device 30.

Electrochemical measurement device 30 is used for electrochemical measurement of objects, such biological samples. The biological sample may be cells and tissues, such as an embryo, that are collected from a living body. Electrochemical measurement device 30 is used for measuring, e.g. a respiratory activity of an embryo.

Electrochemical measurement device 30 includes plate 21 having upper surface 22, well 24 provided in upper surface 22 of plate 21, well 25 formed in upper surface 22 of plate 21 at a position different from a position of well 24, wall 19 separating dividing well 24 from well 25, placement portion 33 provided on bottom surface 24B of well 24, and measuring electrode 34 provided on bottom surface 24B of well 24. Plate 21 has communicating passage 35 provided therein between top end 36 at the outer edge of well 24 and bottom surface 24B of well 24. Communicating passage 35 spatially connects well 24 to well 25. Inside well 25, a counter electrode is configured to be disposed.

Plate 21 further has lower surface 23 opposite to upper surface 22. Plural wells 26 including wells 24 and 25 are provided in upper surface 22 of plate 21. In FIG. 1, six wells 26 are provided. Plate 21 is made of, for example, glass, resin, silicon, or ceramics.

Plate 21 includes wall 19 provided between wells 24 and 25. Wall 19 separates well 24 from well 25. Specifically, wall 19 separates bottom surface 24B of well 24 from bottom surface 25B of well 25. Wall 19 prevents a biological sample introduced into well 24 from moving to well 25. Furthermore, wall 19 divides a measuring liquid contained in wells 24 and 25 into a portion of the measuring liquid contained in well 24 and a portion of the measuring liquid contained in well 25. Thus, wall 19 can reduce impacts of metabolites and other substances derived from a biological sample placed in well 24 on measurement conducted in well 25.

Frame 27 is provided at the outer peripheral portion of upper surface 22 of plate 21. Frame 27 is formed by, for example, integral molding with plate 21 or cutting processing. Reservoir 28 surrounded by frame 27 is provided above the wells 26. Electrochemical measurement device 30 may not necessarily include frame 27 or reservoir 28.

Bottom plate 29 is provided below lower surface 23 of plate 21. Bottom plate 29 is made of, for example, glass, resin, silicon, or ceramics. Circuit board 31 and electrode chip 32 are provided above bottom plate 29. Plate 21 and bottom plate 29 may be unitarily formed by integral molding.

Electrode chip 32 is provided below well 26. Upper surface 32A of electrode chip 32 constitutes bottom surface 26B of well 26. Placement portion 33 and measuring electrodes 34 are disposed on upper surface 32A of electrode chip 32. Placement portion 33 is configured to have a biological sample placed thereon.

Placement portion 33 is implemented by, for example, a recess provided in upper surface 32A of electrode chip 32. The shape of placement portion 33 is appropriately determined according to a biological sample to be measured. Placement portion 33 may be implemented by a flat portion of upper surface 32A of electrode chip 32, for example.

Measuring electrodes 34 are provided around placement portion 33. Measuring electrodes 34 are located away from placement portion 33 by different distances. Measuring electrode 34 is made of, for example, metal, such as platinum, gold, or silver. Alternatively, measuring electrode 34 may be made of conductive material, such as carbon or lithium cobalt oxide. The material of measuring electrode 34 may be selected in consideration of, for example, the composition of the measuring liquid, a voltage necessary for measurement, or an impact on the biological sample.

Wells 26 are recesses formed in plate 21 and electrode chip 32.

Wells 26 including well 24 has, for example, inner wall surface 26C inclining downward with respect to upper surface 22 of plate 21 toward the center of well 26 from the outer edge thereof. Inner wall surface 26C is connected to outer edge 26A and bottom surface 26B of well 26. Well 24 has outer edge 24A located at upper surface 22 of plate 21, bottom surface 24B, and inner wall surface 24C connected to outer edge 24A and bottom surface 24B. Well 25 has outer edge 25A located at upper surface 22 of plate 21, bottom surface 25B, and inner wall surface 25C connected to outer edge 25A and bottom surface 25B.

A through-hole is provided in the bottom of well 26. Placement portion 33 and measuring electrode 34 of electrode chip 32 are exposed from the through-hole. In other words, the upper surface of electrode chip 32 constitutes bottom surface 26B of well 26. Measuring electrode 34 contacts a measuring liquid contained in well 26. The biological sample to be placed in well 26 is introduced onto placement portion 33 from above electrochemical measurement device 30.

Circuit board 31 includes a wiring. Measuring electrode 34 is electrically connected to the wiring of circuit board 31. Circuit board 31 allows the wiring of electrochemical measurement device 30 to be easily designed.

Electrochemical measurement device 30 includes a connection unit to be connected to an external device, such as an electrochemical measuring apparatus. The connection unit is provided, for example, around electrochemical measurement device 30 or on a lower surface of electrochemical measurement device 30.

Electrochemical measurement device 30 includes communicating passage 35 spatially connecting wells 26 to each other. Communicating passage 35 is located in region R26 in a height direction in which wells 26 are provided.

Communicating passage 35 will be particularly described below.

Well 24 is spatially connected to well 25 via communicating passage 35. Communicating passage 35 is provided in region R26 in the height direction between top end 36 at outer edge 24A and bottom surface 24B of well 24 into which the sample is introduced. Wells 24 and 25 are spatially connected to each other, hence allowing the measuring liquid to flow between wells 24 and 25 via communicating passage 35.

In electrochemical measurement device 30, upper surface 19A of wall 19 is located below upper surface 22 of plate 21. In other words, communicating passage 35 is located above wall 19, and upper surface 19A of wall 19 faces communicating passage 35. Thus, electrochemical measurement device 30 can ensure an electrical connection between wells 24 and 25 in a region below top end 36 at outer edge 24A of well 24 via the measuring liquid having conductivity. Top end 36 at outer edge 24A of well 24 is a boundary between well 24 and upper surface 22 of plate 21.

Distance h35 between lower surface 35A of communicating passage 35 and upper surface 22 of plate 21 is equal to or smaller than one third of distance H24 between upper surface 22 of plate 21 and bottom surface 24B of well 24.

Communicating passage 35 is preferably positioned so as to prevent the biological sample from moving between wells 24 and 25.

An operation of electrochemical measurement device 30 will be described below.

In accordance with the embodiment, an embryo is employed as the biological sample.

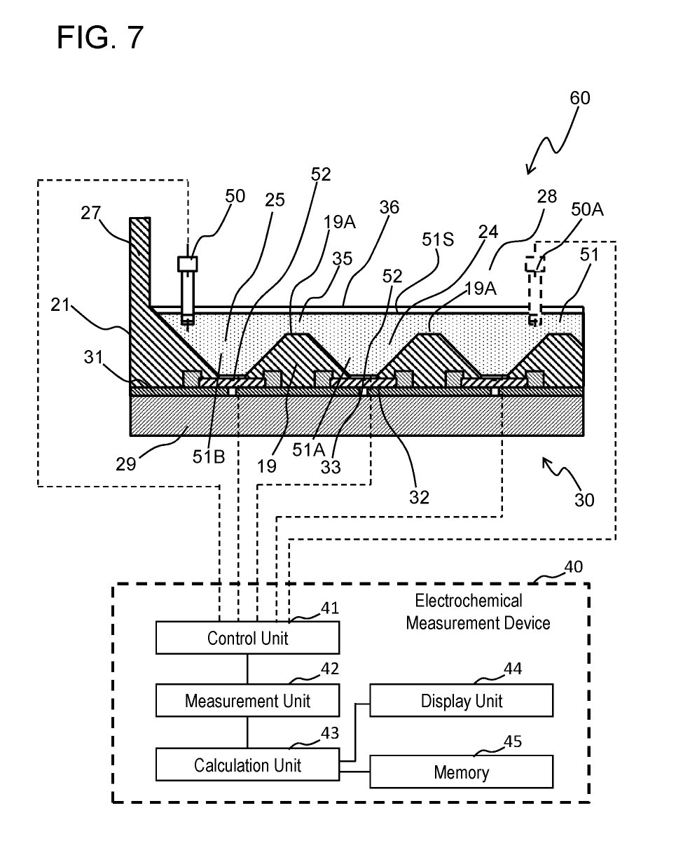

FIG. 7 is a block diagram of electrochemical measurement system 60, for schematically illustrating the operation of electrochemical measurement device 30.

Electrochemical measurement system 60 includes electrochemical measurement device 30 and electrochemical measuring apparatus 40. Electrochemical measurement device 30 is connected to electrochemical measuring apparatus 40 via the connection unit.

Measuring liquid 51 is poured into electrochemical measurement device 30 from above. Measuring liquid 51 is poured so that liquid surface 51S of measuring liquid 51 is located above upper surface 19A of wall 19. Upper surface 19A is located below top end 36 at outer edge 24A of well 24 of electrochemical measurement device 30. Thus, portion 51A of conductive measuring liquid 51 contained in well 24 is electrically connected to portion 51B of measuring liquid 51 contained in well 25.

Next, biological samples 52, embryos are introduced onto respective placement portions 33 of wells 26. One biological sample 52 is introduced into one well 26. Bottom surfaces 26B (24B, 25B) of wells 26 (24, 25) have respective placement portions 33 each configured to have biological sample 52 placed thereon.

Subsequently, counter electrode 50 is inserted into well 25 so as to contact the measuring liquid. Counter electrode 50 is made of, for example, noble metal, such as platinum, gold, or silver. The material of counter electrode 50 is selected in consideration of the composition of measuring liquid 51 in the measurement, and a voltage and a current required for the measurement.

For the purpose of determining the potential of measuring electrode 34 more accurately, reference electrode 50A may be provided so as to contact measuring liquid 51. Reference electrode 50A is made of, for example, noble metal, such as platinum, gold, or silver. The material of reference electrode 50A is selected in consideration of the composition of measuring liquid 51 in the measurement and a voltage and a current required for the measurement. Electrochemical measurement system 60 may not necessarily include reference electrode 50A. In this case, counter electrode 50 may function as reference electrode 50A.

Electrochemical measuring apparatus 40 includes control unit 41, measuring unit 42, and calculation unit 43.

Control unit 41 is configured to apply a measurement potential to measuring electrode 34 and counter electrode 50.

For example, in electrochemical measurement in well 24, a measurement potential is applied between well 24 and counter electrode 50. The applied potential causes an oxidation-reduction current to flow between measuring electrode 34 of well 24 and counter electrode 50 disposed in well 25.

Measuring unit 42 is configured to measure the oxidation-reduction current flowing between measuring electrode 34 of well 24 and counter electrode 50.

Calculation unit 43 is configured to calculate a respiratory activity value of biological sample 52 based on the measured oxidation-reduction current.

Similarly, electrochemical measurement in well 25 can be performed by measuring an oxidation-reduction current flowing between measuring electrode 34 of well 25 and counter electrode 50.

Control unit 41, measuring unit 42, and calculation unit 43 are implemented by, for example, circuits including a sensor and a semiconductor. Control unit 41, measuring unit 42, and calculation unit 43 may be independently configured or may be integrally configured.

Electrochemical measuring apparatus 40 may include, for example, display unit 44 for displaying information, such as measured current values and calculation results, and memory unit 45 for storing such information.

As described above, electrochemical measurement device 30 performs electrochemical measurement in plural wells 26 with using one counter electrode 50 with a small amount of measuring liquid 51. Therefore, it is not necessary to fill electrochemical measurement device 30 with measuring liquid 51 to top end 36 at outer edge 24A of well 24.

In the above-mentioned conventional chip for respiration measurement, when electrochemical measurement is performed in each of plural wells, a counter electrode and a reference electrode necessary for the measurement are inserted into the wells. This inserting of the counter electrode and the reference electrode into the wells into which a biological sample is introduced needs to be carefully performed in consideration of positions of the electrodes with respect to the biological sample. Thus, when the biological samples introduced into the wells are sequentially measured, an operator needs to perform the insertion and extraction of the counter electrode and the working electrode into and from the wells. The operator needs to repeat such troublesome operation. Hence, the use of this chip for respiration measurement increases a time to perform electrochemical measurement.

In electrochemical measurement device 30 according to the embodiment, when biological samples 52 introduced into respective wells 26 are measured, it is not necessary to move counter electrode 50 at every measurement in wells 26, accordingly reducing operation burdens on an operator. Thus, electrochemical measurement device 30 can perform electrochemical measurement in a shorter time.

In the measurement, counter electrode 50 is an obstacle to operation. Therefore, well 25 in which counter electrode 50 is disposed is preferably located outside well 24. This arrangement reduces operation burdens on the operator.

Well 24 is disposed from well 25 in predetermined direction D30, as illustrated in FIG. 2. Distance L1 between wall 19 and end 16 of plate 21 in predetermined direction D30 is larger than distance L2 between wall 19 and end 17 of plate 21 opposite to end 16 in predetermined direction D30.

In the case where frame 27 is provided on upper surface 22 of plate 21, the end portion of plate 21 is the boundary between upper surface 22 and the inner surface of frame 27.

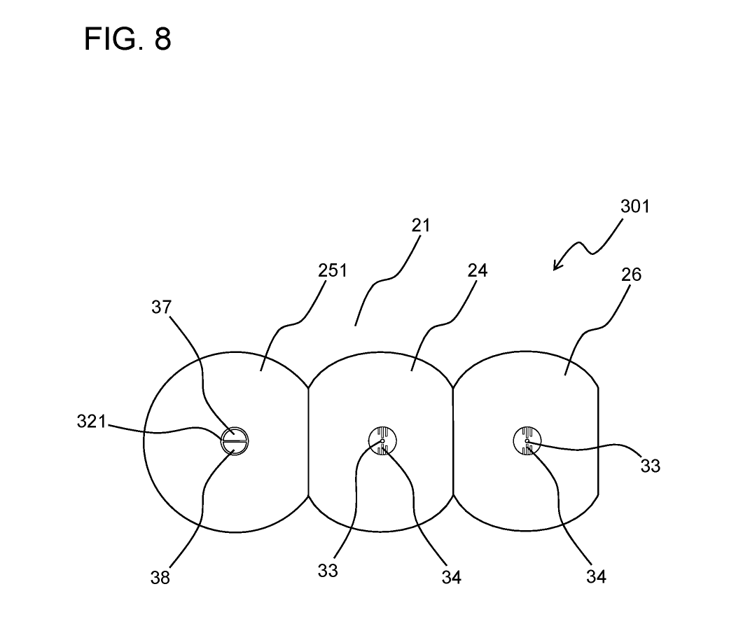

FIG. 8 is a top view of another electrochemical measurement device 301 according to the embodiment. In FIG. 8, components identical to those of electrochemical measurement device 30 illustrated in FIGS. 1 to 7 are denoted by the same reference numerals. In electrochemical measurement device 301 illustrated in FIG. 8, plate 21 has well 251 therein instead of well 25. Electrochemical measurement device 301 includes counter electrode 37 and reference electrode 38 which are provided on the bottom surface of well 251. Counter electrode 37 has a semicircular shape. Reference electrode 38 has a semicircular shape.

Counter electrode 37 and reference electrode 38 are provided on the upper surface of electrode chip 321 located below well 251. Counter electrode 37 and reference electrode 38 are exposed from a through-hole formed in the bottom of a recess of plate 21. In other words, counter electrode 37 and reference electrode 38 contact measuring liquid 51.

Well 251 has neither a measuring electrode nor a placement portion therein. In other words, electrochemical measurement device 301 does not perform electrochemical measurement of a biological sample in well 251.

In electrochemical measurement in well 24, electrochemical measurement device 301 measures an oxidation-reduction current flowing between counter electrode 37 and measuring electrode 34 of well 24.

As described above, counter electrode 37 provided in well 251 allows electrochemical measurement device 301 to perform electrochemical measurement in plural wells 26 other than well 251. Electrochemical measurement device 301 does not require counter electrode 50 inserted in the measurement.

This configuration reduces burdens on the operator, and decreases a time required for the measurement. Counter electrode 50 is generally expensive. Hence, counter electrode 50 is repeatedly used in electrochemical measurement. Such repetitive usage of counter electrode 50 may contaminate counter electrode 50. Contaminated counter electrode 50 may be an obstacle against stable measurement. Electrochemical measurement device 30 according to the embodiment employs disposable counter electrode 37, and therefore, can perform the measurement more stably.

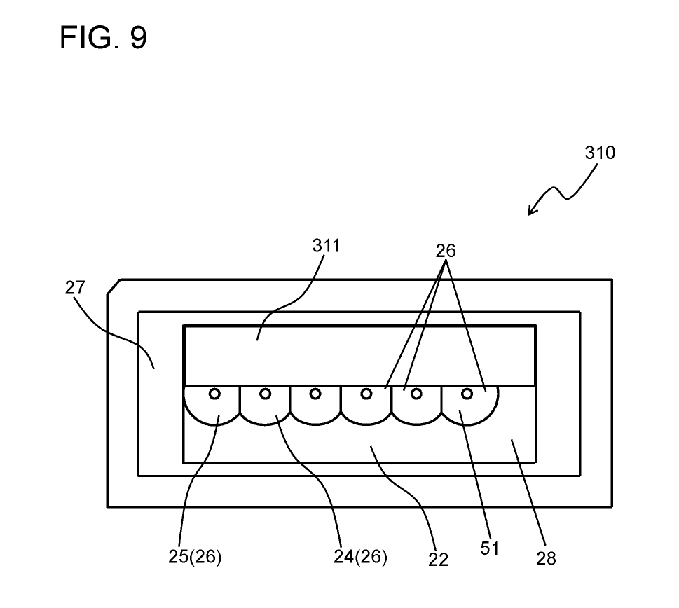

FIG. 9 is a top view of still another electrochemical measurement device 310 according to the embodiment. In FIG. 9, components identical to those of electrochemical measurement device 30 illustrated in FIGS. 1 to 7 are denoted by the same reference numerals.

Electrochemical measurement device 310 further includes cover 311 partially covering wells 24 and 25. Cover 311 prevents measuring liquid 51 contained in well 26 from leaking to reservoir 28. During the measurement, biological sample 52 is introduced into and taken out of electrochemical measurement device 310. Therefore, in consideration of operability for an operator, cover 311 preferably partially covers wells 26. In other words, wells 26 are preferably partially exposed from cover 311. In accordance with the embodiment, cover 311 covers about 40% to 50% of each well 26.

Cover 311 is fixed on upper surface 22 of plate 21. Cover 311 is arranged such that placement portion 33 provided inside each of wells 26 is exposed viewing from above. Cover 311 does not overlap placement portion 33, and allows the operator to introduce biological sample 52 while observing biological sample 52 from above with a microscope.

In the case where cover 311 is made of transparent material, cover 311 may cover the entirety of wells 26. In this case, biological sample 52 is introduced and taken out by removing cover 311.

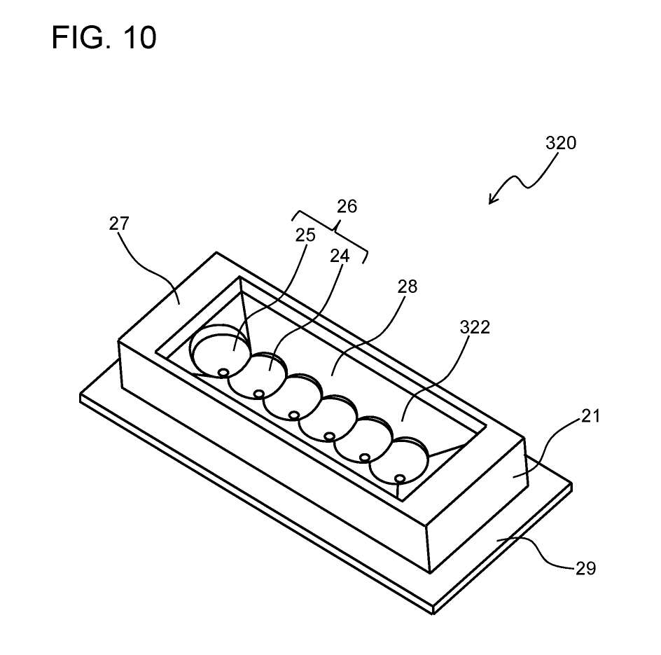

FIG. 10 is a perspective view of further electrochemical measurement device 320 according to the embodiment. In FIG. 10, components identical to those of electrochemical measurement device 30 illustrated in FIGS. 1 to 7 are denoted by the same reference numerals.

Upper surface 322 of electrochemical measurement device 320 inclines downward toward well 24 and well 25 from the outer periphery of plate 21.

Inclining upper surface 322 allows measuring liquid 51 jumped out of well 26 to flow back into wells 26. This configuration prevents measuring liquid 51 from decreasing due to the jumping-out of measuring liquid 51.

### (Modification 1)

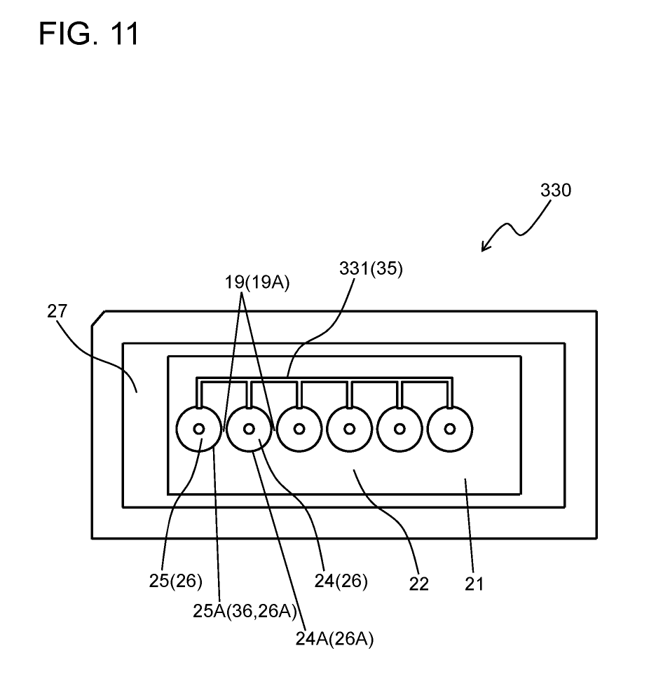

FIG. 11 is a top view of electrochemical measurement device 330 according to Modification 1. In FIG. 11, components identical to those of electrochemical measurement device 30 illustrated in FIGS. 1 to 7 are denoted by the same reference numerals.

In electrochemical measurement device 330, groove 331 is formed in upper surface 22 of plate 21.

Groove 331 is formed in upper surface 22 of plate 21. In other words, the bottom surface of groove 331 is located below top end 36 at outer edge 24A of well 24.

Groove 331 is connected to plural wells 26 including wells 24 and 25.

Groove 331 functions as communicating passage 35 for spatially connecting well 24 to well 25.

Groove 331 does not overlap wall 19 provided between plural wells 26. In other words, upper surface 19A of wall 19 between wells 24 and 25 is located at the same height as top end 36 at outer edge 24A of well 24. This configuration prevents measuring liquid 51 and biological sample 52 from moving between wells 24 and 25. Upper surface 19A of wall 19 provided between wells 24 and 25 may be located above the top end of outer edge 24A of well 24. This configuration prevents measuring liquid 51 and biological sample 52 from moving between wells 24 and 25.

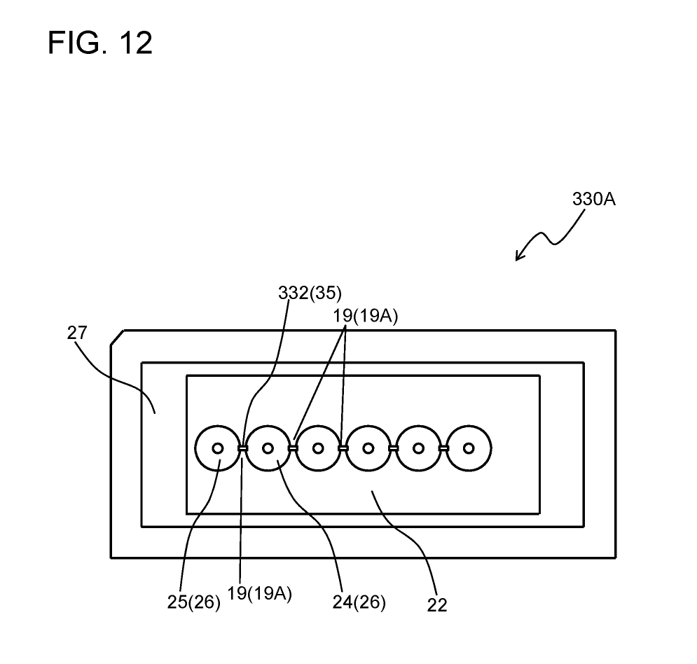

FIG. 12 is a top view of another electrochemical measurement device 330A according to Modification 1. In FIG. 12, components identical to those of electrochemical measurement device 330 illustrated in FIG. 11 are denoted by the same reference numerals. In electrochemical measurement device 330A illustrated in FIG. 12, groove 332 serving as communicating passage 35 is formed in upper surface 19A of wall 19 separating well 24 from well 25.

This configuration allows electrochemical measurement device 330A to perform electrochemical measurement in plural wells 26 with single counter electrode 50 with a small amount of measuring liquid 51.

### (Modification 2)

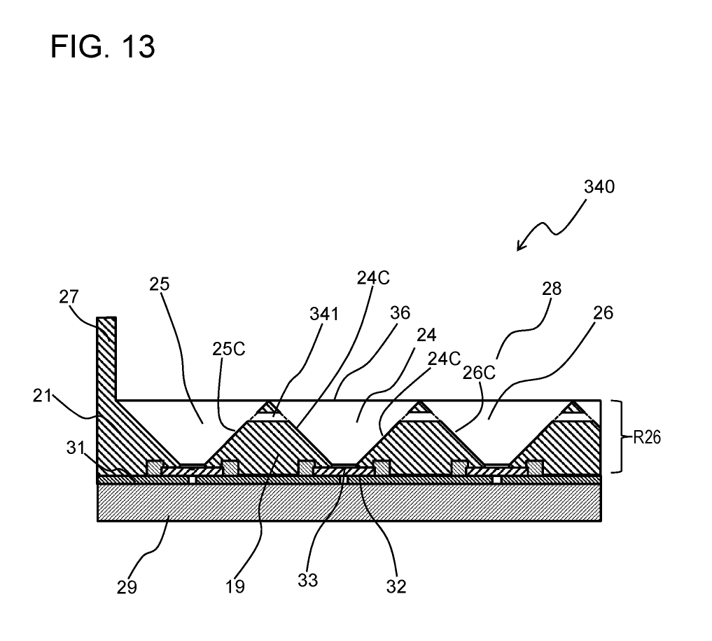

FIG. 13 is a cross-sectional view of electrochemical measurement device 340 according to Modification 2. In FIG. 13, components identical to those of electrochemical measurement device 30 illustrated in FIGS. 1 to 7 are denoted by the same reference numerals.

In electrochemical measurement device 340, through-hole 341 is formed in wall 19 separating well 24 from well 25. Through-hole 341 penetrates from inner wall surface 24C of well 24 to inner wall surface 25C of well 25. In other words, through-hole 341 penetrates from inner wall surface 26C of one well 26 to inner wall surface 26C of another well 26.

Through-hole 341 is formed in wall 19. Through-hole 341 is provided in region R26 between top end 36 at outer edge 24A of well 24 and bottom surface 24B of well 24 in the height direction. In other words, the upper surface of through-hole 341 is located below top end 36 of outer edge 24A of well 24. Furthermore, the lower surface of through-hole 341 is located above bottom surface 24B of well 24.

Through-hole 341 serves as communicating passage 35 spatially connecting well 24 to well 25.

This configuration allows electrochemical measurement device 340 to perform electrochemical measurement in plural wells 26 with single counter electrode 50 with a small amount of measuring liquid 51.

The electrochemical measurement device may not necessarily include circuit board 31 or electrode chip 32. For example, a recess formed in the plate and having no through-hole may serve as well 26. In this case, placement portion 33 and measuring electrode 34 are formed on the bottom surface of the recess. Furthermore, placement portion 33 and measuring electrode 34 may be provided on bottom plate 29.

Measuring liquid 51 may fill up the inside of reservoir 28 surrounded by frame 27 of electrochemical measurement device 30. This configuration allows counter electrode 50 to be electrically connected via measuring liquid 51 to measuring electrodes 34 (a working electrodes) disposed in each of wells 26. This configuration allows electrochemical measurement device 30 to measure biological samples 52 introduced into respective wells 26 with using single counter electrode 50. In this case, counter electrode 50 contacts measuring liquid 51, and is inserted into, for example, the inside of well 26 or reservoir 28.

Measuring liquid 51 in electrochemical measurement device 30 flows when electrochemical measurement device 30 moves or vibrates. When measuring liquid 51 fills up reservoir 28 above the level of top end 36 of outer edge 26A of well 26, the amount of measuring liquid 51 is increased, and accordingly, a large amount of measuring liquid 51 flows between plural wells 26. Such flow of measuring liquid 51 may causes biological sample 52 to float from placement portion 33 and move. Biological sample 52 often has a small size, for example, ranging from 50 μm to 300 μm. Therefore, the movement of biological sample 52 caused by the flow of measuring liquid 51 may cause a problem, such as out of sight of biological sample 52.

To avoid such a problem, measuring liquid 51 preferably fills the electrochemical measurement device so as not to exceed the level of top end 36 of outer edge 26A of well 26. As described above, in electrochemical measurement device 30, well 24 is connected with well 25 in region R26 between top end 36 at outer edge 24A of well 24 and bottom surface 24B of well 24. Therefore, even a small amount of measuring liquid 51 allows a current to flow between measuring electrodes 34 and each of counter electrodes 50 and 37 disposed in well 25. By performing measurement using a small amount of measuring liquid 51, electrochemical measurement device 30 can prevent the movement of biological sample 52 due to the flow of measuring liquid 51. An operator can perform electrochemical measurement of the biological sample with a small amount of measuring liquid 51, and therefore, can perform measurement without losing sight of biological sample 52.

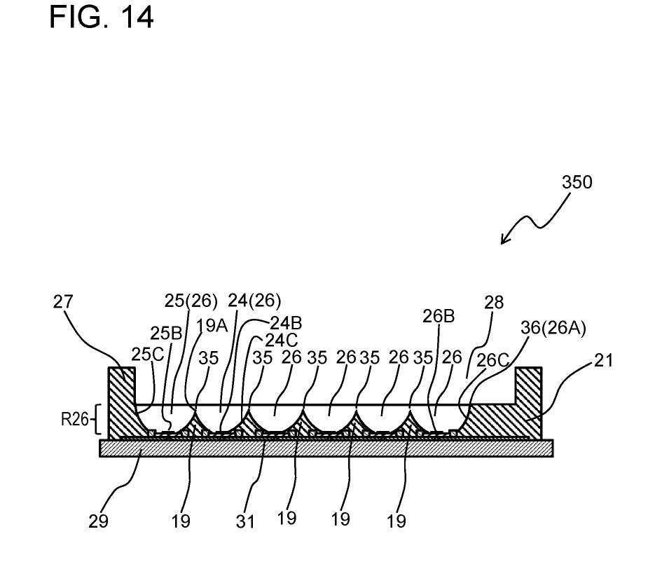

FIG. 14 is a cross-sectional view of further electrochemical measurement device 350 according to the embodiment. In FIG. 14, components identical to those of electrochemical measurement device 30 illustrated in FIGS. 1 to 7 are denoted by the same reference numerals. In electrochemical measurement device 350 illustrated in FIG. 14, inner wall surfaces 26C (24C, 25C) of wells 26 (24, 25) are concave toward outside wells 26 (24, 25).

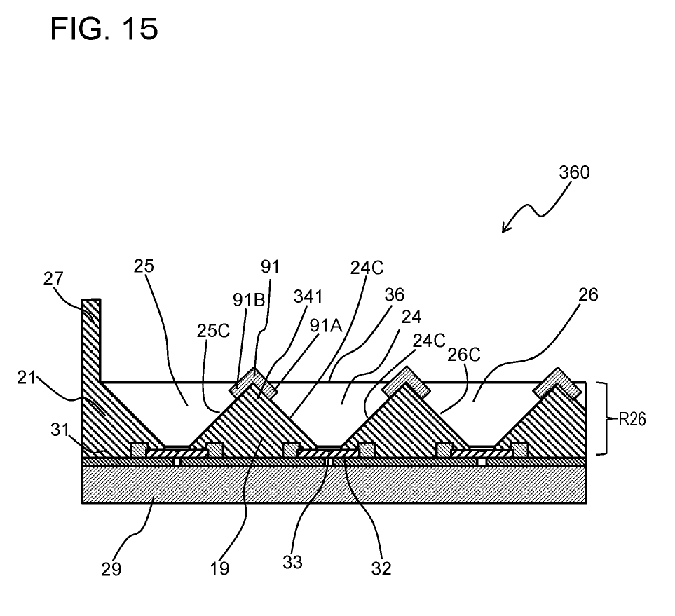

FIG. 15 is a cross-sectional view of further electrochemical measurement device 360 according to the embodiment. In FIG. 15, components identical to those of electrochemical measurement device 30 illustrated in FIGS. 1 to 7 are denoted by the same reference numerals. Electrochemical measurement device 360 further includes electrode 91 connecting well 24 to well 25 to ensure electrical connection between wells 24 and 25. Electrode 91 includes end portions 91A and 91B. End portion 91A of electrode 91 is located on inner wall surface 24C between outer edge 24A of well 24 and bottom surface 24B of well 24. End portion 91B of electrode 91 is located on inner wall surface 25C between outer edge 25A of well 25 and bottom surface 25B of well 25. Electrode 91 is away from bottom surfaces 24B and 25B (26B) of wells 24 and 25 (26), but may reach bottom surfaces 24B and 25B (26B) of wells 24 and 25 (26). Electrode 91 is made of, for example, the same material as measuring electrode 34.

In electrochemical measurement device 360, a portion of the measuring liquid contained in well 24 (26) may not necessarily contact a portion of the measuring liquid contained in well 25 (26), and may be separated from the portion of the measuring liquid contained in well 25 (26). Portion 91A of electrode 91 contacts the portion of the measuring liquid contained in well 24 while portion 91B of electrode 91 is electrically connected to the portion of the measuring liquid contained in well 25. This configuration allows the portion of the measuring liquid contained in well 24 to be electrically connected via electrode 91 to the portion of the measuring liquid contained in well 25.

Communicating passage 35 of electrochemical measurement device 30, groove 331 of electrochemical measurement device 330, through-hole 341 of electrochemical measurement device 340, and electrode 91 of electrochemical measurement device 360 constitute conductive passages electrically connecting between portion 51A of measuring liquid 51 contained in well 24 and portion 51B of measuring liquid 51 contained in well 25.

Up to this point, the electrochemical measurement devices and the electrochemical measurement system according to one or a plurality of aspects have been described on the basis of the embodiment and the modifications, but the present disclosure is not limited to the embodiment. Various modifications to the embodiment that are conceivable by those skilled in the art and forms configured by combining the constituents in the different embodiment and modifications may be included in the scope of one or a plurality of aspects as long as they do not depart from the spirit of the present disclosure.

In the embodiment, terms, such as “upper surface”, “lower surface”, “above”, and “below”, indicating directions indicate relative directions determined only by the relative positional relationship of constituent components of the electrochemical measurement device, and do not indicate absolute directions, such as a vertical direction.

### INDUSTRIAL APPLICABILITY

An electrochemical measurement device and an electrochemical measurement system according to the present disclosure are particularly useful as a device for examining and analyzing activity of biological samples.

### REFERENCE MARKS IN THE DRAWINGS

19 wall
21 plate
22, 322 upper surface
23 lower surface
24 well (first well)
24A outer edge
24B bottom surface
24B inner wall surface
25, 251 well (second well)
25A outer edge
25B bottom surface
26B inner wall surface
26 well
26A outer edge
26B bottom surface
26B inner wall surface
27 frame
28 reservoir
29 bottom plate
30, 301, 310, 320, 330, 340 electrochemical measurement device
31 circuit board
32, 321 electrode chip
37 counter electrode
38 reference electrode
40 electrochemical measuring apparatus
41 control unit
42 measuring unit
43 calculation unit
44 display unit
45 memory unit
50 counter electrode
60 electrochemical measurement system
311 cover
331, 332 groove
341 through-hole

1. An electrochemical measurement device configured to measure an activity of a biological sample with a measuring liquid having conductivity, the electrochemical measurement device comprising:
a plate having an upper surface, the plate having a first well and a second well which are provided in the upper surface at positions different from each other, a first well having a bottom surface, a second well having a bottom surface, the plate including a wall separating the bottom surface of the first well from the bottom surface of the second well;
a measuring electrode disposed inside the first well; and
a first placement portion provided on the bottom surface of the first well, the first placement portion being configured to have the biological sample placed thereon,
wherein the measuring electrode is provided on the bottom surface of the first well around the first placement portion,
wherein the second well is configured to have a counter electrode disposed therein,
wherein the first well and the second well are configured to contain the measuring liquid therein, and
wherein a portion of the measuring liquid contained in the first well is electrically connected to a portion of the measuring liquid contained in the second well.

2. The electrochemical measurement device according to claim 1,
wherein the first well further has an outer edge and an inner wall surface connected to the outer edge and the bottom surface of the first well, and
wherein the plate has a communicating passage therein, the communicating passage opening to the inner wall surface of the first well above the bottom surface of the first well to allow the first well to communicate with the second well, and when the communicating passage is filled with the measuring liquid, the communicating passage electrically connecting the portion of the measuring liquid contained in the first well to the portion of the measuring liquid contained in the second well upon being filled with the measuring liquid.

3. The electrochemical measurement device according to claim 2, wherein the communicating passage is located above the wall.

4. The electrochemical measurement device according to claim 2, wherein the communicating passage comprises a through-hole provided in the wall.

5. The electrochemical measurement device according to claim 2, wherein the communicating passage comprises a groove provided in the upper surface of the plate so as to connect the first well to the second well.

6. The electrochemical measurement device according to claim 5, wherein the groove is provided in an upper surface of the wall.

7. The electrochemical measurement device according to claim 1, wherein the counter electrode is configured to be provided on the bottom surface of the second well.

8. The electrochemical measurement device according to claim 1, further comprising
a working electrode provided inside the second well,
wherein the bottom surface of the second well includes a second placement portion configured to have the biological sample placed thereon, and
wherein the working electrode is provided on the bottom surface of the second well around the second placement portion.

9. The electrochemical measurement device according to claim 1, wherein the upper surface of the plate inclines downward toward the first well and the second well from outside the upper surface of the plate.

10. The electrochemical measurement device according to claim 1, further comprising a frame provided at an outer periphery of the upper surface of the plate.

11. The electrochemical measurement device according to claim 1, further comprising a cover provided on the upper surface of the plate so as to cover the first well and the second well.

12. The electrochemical measurement device according to claim 11, wherein the first placement portion of the first well is exposed from the cover viewing from above.

13. The electrochemical measurement device according to claim 1,
wherein the first well further has an inner wall surface extending from an outer edge of the first well to the bottom surface of the first well, and
wherein the inner wall surface of the first well is concave toward outside the first well.

14. The electrochemical measurement device according to claim 1,
wherein the first well further has an inner wall surface extending from an outer edge of the first well to the bottom surface of the first well, and
wherein the inner wall surface of the first well inclines with respect to the upper surface of the plate.

15. The electrochemical measurement device according to claim 1,
wherein the second well is disposed in a predetermined direction from the first well, and
wherein a distance between the wall and an end of the plate in the predetermined direction is larger than a distance between the wall and another end of the plate opposite to the end of the plate in the predetermined direction.

16. The electrochemical measurement device according to claim 1, wherein a distance between a bottom surface of the communicating passage and the upper surface of the plate is equal to or smaller than one third a distance between the bottom surface of the first well and the upper surface of the plate.

17. The electrochemical measurement device according to claim 1, further comprising
an electrode including a first portion located inside the first well and a second portion located inside the second well,
wherein the first portion of the electrode contacts the portion of the measuring liquid contained in the first well, and the second portion of the electrode contacts the portion of the measuring liquid contained in the second well, thereby electrically connecting the portion of the measuring liquid contained in the first well with the portion of the measuring liquid contained in the second well.

18. An electrochemical measurement system for electrochemically measuring a biological sample with using a measuring liquid having conductivity, the electrochemical measurement system comprising:
an electrochemical measurement device; and
an electrochemical measuring apparatus,
wherein the electrochemical measurement device includes:
a plate having an upper surface, the plate having a first well and a second well which are provided in the upper surface at positions different from each other, the first well having a bottom surface, the second well having a bottom surface, the plate including a wall separating the bottom surface of the first well from the bottom surface of the second well;
a measuring electrode disposed inside the first well;
a counter electrode disposed inside the second well; and
a placement portion provided on the bottom surface of the first well, the placement portion being configured to have the biological sample placed thereon,
wherein the measuring electrode is provided around the first placement portion on the bottom surface of the first well,
wherein the first well and the second well are configured to contain the measuring liquid therein,
wherein a portion of the measuring liquid contained in the first well is electrically connected to a portion of the measuring liquid contained in the second well,
wherein the electrochemical measuring apparatus includes:
a control unit that applies a potential to the measuring electrode;
a measuring unit that measures a current flowing in the measuring electrode; and
a calculation unit that calculates an amount of an activity of the biological sample based on the measured current.

19. The electrochemical measurement system according to claim 18, wherein the plate has a communicating passage therein, the communicating passage communicating with the first well above the bottom surface of the first well to allow the first well to communicate with the second well.
